(19) United States
(12) Patent Application Publication
(10) Pub. No.: US 2014/0152664 A1
(43) Pub. Date: Jun. 5, 2014

(54) METHOD OF RENDERING A TERRAIN STORED IN A MASSIVE DATABASE

(71) Applicant: THALES, Neuilly-sur-Seine (FR)

(72) Inventor: Gildas LE MEUR, Cergy Pontoise (FR)

(21) Appl. No.: 14/093,344

(22) Filed: Nov. 29, 2013

(30) Foreign Application Priority Data
Nov. 30, 2012 (FR) 12 03242

(51) Int. Cl. G06T 3/40

(52) U.S. Cl. CPC G06T 3/40
USPC 345/428

(57) ABSTRACT

A method of rendering a terrain stored in a massive database the said terrain rendering being displayed for an observer by a display device comprising at least one graphics card comprising a cache memory, comprises at least: a step of generating several regular grids of different resolution level terrain patches so as to represent the terrain data of the massive database; a step of extracting terrain data from the massive database for several resolution levels, the extracted terrain data forming an extraction pyramid, composed of an extraction window for each level of detail, placed in cache memory. Each window comprises an active zone intended to be displayed, and a preloading zone which makes it possible to anticipate the transfers of data; a step of selecting the patches of the extraction pyramid which contribute to the image; and a step of plotting the rendering on the basis of the selected patches.

### CROSS-REFERENCE TO RELATED APPLICATION

This application claims priority to foreign French patent application No. FR 1203242, filed on Nov. 30, 2012, the disclosure of which is incorporated by reference in its entirety.

### FIELD OF THE INVENTION

The present invention relates to a method of rendering a terrain stored in a massive database. The invention is notably applicable to the generation of synthesis images by simulation software within the framework of training a pilot to pilot a craft.

### BACKGROUND

The generation of synthesis images representing an outside setting can apply to numerous contexts: for example, for the training of pilots of craft using a simulator of the craft and of its environment evolving in real time. The training can apply to helicopter pilots, and also to drivers of terrestrial craft. The generation of synthesis images can also apply to computer games so as to simulate an outside environment. Most simulation systems using the generation of synthesis images comprise a database in which all the data describing an evolving terrain is stored. For the utilization of these terrain data and their display, for example on a screen facing the pilot to be trained, the simulation systems comprise a graphics card comprising notably processors dedicated to the computation of the data to be displayed, and a video memory which can be used by the simulation system as a level 1 cache. Likewise, the main memory of the motherboard can be used by these systems as a level 2 cache. Hereinafter, the terms cache or cache memory will be used interchangeably. The terrain data are generally described on the one hand with information of geometric type, comprising notably vertices defined by attributes such as position and normal vector, and information of image type, which makes it possible to overlay a texture onto the geometric representation, for example an aerial photo. These data are therefore utilized by the graphics card, which manages the display of the terrain data in the form of images. The images can for example be displayed on a screen. The computations performed by the graphical processor for the representation of the terrain data use notably a terrain rendering method.

One of the problems related to the rendering of terrain in an outside setting is that the outside environment is described by means of terrain data of significant size. Indeed, an outside setting is not always bounded by a wall for example but may extend as far as a horizon. The terrain data are notably stored in a persistent manner in a “massive” database, so-called on account of its significant size in terms of volume of stored data. The utilization of massive databases is very complex and expensive in computation time and in cache memory in respect of the processors for handling these data. Notably it is impossible to work on massive databases with conventional database management and access tools. The management and access tools are notably software that manages accesses to the databases.

Having regard to the current limits of computers, as much in terms of memory capacity as in terms of processing of geometric data for a display, a customary tendency is to resort to so-called “levels-of-detail” techniques when it is desired to maintain a stable, real-time, refresh rate for the image.

The levels-of-detail techniques consist in simplifying the representation of the elements of the scene, as a function of their contribution to the rendered image. This contribution can be estimated on the basis of various criteria, such as the distance between the element to be displayed and the viewpoint of the observer, or else an evaluation of the projected surface area of the element to be displayed in the rendered image. The greater the distance of the element to be displayed from the observer, or the smaller the projected surface area of the element to be displayed in the rendered image, the more it will be possible to allow a degradation in the precision of the representation of this element.

To render a terrain by using levels-of-detail techniques, it is possible to rely on two families of technique: so-called discrete levels-of-details techniques, and so-called continuous levels-of-details techniques. The discrete levels-of-details techniques consist in pre-computing several more or less detailed representations of one and the same element of the scene. During display, that pre-computed representation which makes it possible to achieve the best compromise between the cost of processing and the richness of the display is selected from among the pre-computed representations. These techniques are particularly suited to the processing of objects repeated in the scene, such as trees. The continuous levels-of-details techniques are based on a meshing of an element of the scene, whose mesh cells are simplified locally according to a criterion making it possible to estimate the error introduced by the simplification of the mesh cells in the rendered image. To limit the cost of processing of the simplification of the mesh, these techniques rely on a much more restrictive organization of the data of the element represented, and generally apply only to a subset of the elements of the database, in particular the surface of the ground.

For the processing of the data of image type, specific levels-of-detail techniques are used, the most widespread of which is mipmapping. Mipmapping is a technique for applying textures, the mipmaps, which makes it possible to improve the quality of the display by reducing, by filtering, any aliasing artefacts, that is to say any staircasing, while limiting the cost of the filtering so as to allow real-time rendering. The prefix mip comes from the Latin expression “multum in parvo”, which signifies literally “many things in a small place”. The suffix map originates from the English term, which can be regarded in this context as equivalent to image. A mipmap is based on a collection of pre-computed images, which accompanies a main texture. Each pre-computed image is obtained by filtering the initial texture, and can be likened to a level of detail of the initial texture. For example, on the basis of an image 256×256 pixels in size, will be produced the same images at the resolutions of 128×128 pixels, 64×64, 32×32, 16×16, 8×8, 4×4, 2×2 and 1×1. During the display of an object textured by a mipmap, the filtering operation consists in sampling the texture by using the images whose resolution is the closest to that which corresponds to the projection on the screen of the textured surface of the object. With respect to the original texture, the use of mipmaps introduces a memory cost overhead of the order of thirty percent.

Various levels-of-detail techniques are described in the following publications:
Enrico Gobetti, Fabio Marton, Paolo Cignoni, Marco Di Benedetto, Fabio Ganovelli. C-bdam—compressed batched dynamic adaptive meshes for terrain rendering. Computer Graphics Forum, 25(3), September 2006;
Christopher C. Tanner, Christopher J. Migdal, Michael T. Jones. The clipmap: a virtual mipmap. SIGGRAPH' 98, Proceedings of the 25th annual conference on Computer Graphics and interactive techniques, pp 151-158, NY, USA, 1998. ACM Press;
Frank Lossasso, Hugues Hoppe. Geometry clipmaps: terrain rendering using nested regular grids. SIGGRAPH' 2004, volume 23(3), pp 769-776, NY, USA, 2004. ACM Press;
Peter Lindstrom, Valerio Pascucci. Terrain Simplification simplified: A general framework for view-dependent out-of-core visualization. IEEE Transactions on Visualization and Computer Graphics, 8(3), pp 239-254, 2002;
Roland Wahl, Manuel Massing, Patrick Degener, Michael Guthe, Reinhard Klein. Scalable compression and rendering of textured terrain data. Journal of WSCG, volume 12, 2004.

Gobetti et al., Tanner et al., Lassosso et al., Lindstrom et al. use levels-of-detail techniques for a large dimension terrain display and endeavour to locally adapt the complexity of the elements displayed for a point of interest, as a function of the contribution of each element to the rendered image for this point of interest.

More precisely, Enrico Gobetti et al. describe a multi-resolution terrain representation, compressed so as to support interactive rendering over a very wide plane, of spherical terrain surfaces. The technique described is named C-BDAM for Compressed Batched Dynamic Adaptive Meshes. The C-BDAM technique is an extension of the BDAM and P-BDAM techniques, BDAM being an acronym for the expression Batched Dynamic Adaptive Meshes and P-BDAM being an acronym for the expression Planet-Sized Batched Dynamic Adaptive Meshes. The C-BDAM technique uses notably a hierarchy in the levels of detail of the slicing of the terrain.

Tanner et al., for their part, describe a procedure termed “clipmap”, which consists of a technique for representing a dynamic texture, so as to effect a rendering of terrains of large dimension in real time. Clipmap is an expression which can be regarded as equivalent to sliced image. A clipmap procedure is by definition a mipmap “clipping” procedure, aimed at limiting the memory footprint of the texture data. Clipping is an expression signifying literally slicing. The approach of Tanner et al. consists in slicing each level of detail of the mipmap into tiles, so as to be able to manage textures of very large size, that may for example attain a side length of several hundred thousand pixels, by virtue of a method of cache management. During display, only a small portion of the complete texture is loaded into memory: for each level of detail of the texture, a cache which contains the tiles corresponding to the image data which have the most chance of being used for the rendering is managed. This cache is updated dynamically, and in an incremental manner, as a function of the displacements of the viewpoint.

Frank Lossasso et al. extend the “clipmap” technique to the management of the data describing the terrain geometry. The latter must be able to be represented in the form of a regular grid, each cell of which represents a point of the terrain. The first two coordinates of a point are deduced implicitly from the grid row and column indices, whereas the third coordinate, which corresponds to the altitude, is given by the value of the associated cell. The geometric data are then managed in memory as a clipmap texture, forming a set of nested regular grids, centred on the viewpoint. Lossasso et al. describe particularly a method which ensures geometric continuity between the various levels of detail used for the display from a viewpoint.

Peter Lindstrom et al. describe a general application framework for a computation for rendering a terrain, stored on an external memory, so as to generate representations of massive terrain surfaces. The two key principles of the proposed application framework are the following: a refining of the meshing of the terrain dependent on the position of the observer, and a simple scheme for organizing the terrain data, to improve coherence and reduce the number of pagination events between external storage of the terrain and the main memory of a computer. Like numerous previously proposed procedures for refining a meshing of the terrain dependent on viewpoint, Lindstrom et al. use a recursive subdivision of a triangular mesh to define a regular mesh of terrain data. For each rendering, the algorithm decomposes into three main steps: generation of an adaptive mesh representing the terrain, elimination of the triangles not being in the visibility volume, and management of the transitions of levels of detail of the adaptive mesh by using geo-morphing.

Roland Wahl et al. start from the principle that, for massive terrain databases, the use of pre-computed tiles is more efficient than the procedures with continuous levels of details, and consists in solving the following problems: on the one hand the partitioning and the simplification of the original data, and on the other hand the implementation of a rendering algorithm making it possible to obtain good precision, the current approaches often amounting to establishing a compromise between the approximation error in the image space and the rendering refresh rate. To solve these problems, Roland Wahl et al. propose a particular data structure and a particular levels-of-details technique. Their approach allows real-time rendering of datasets stored in an external manner, while guaranteeing pixel precision in the image space between the geometries and the textures displayed, and those of the origin data.

Thus, numerous procedures exist for obtaining efficient terrain rendering on the basis of terrain description data stored on an external memory. However, recourse to these specific techniques complicates both the production of data and the development of the rendering software. In particular, these techniques induce restrictions on the geometric representation of the data, which render them inapplicable to the urbanized zones of the terrain, comprising notably buildings. These zones are then particular cases that have to be managed in a specific manner. Moreover it is then necessary to manage the continuity between the non-urbanized zones and the other zones, thereby further complicating the software.

More precisely, most of the current solutions using level-of-detail techniques to display the terrain make the assumption that, at any point of the terrain surface, the terrain is defined by one and only one altitude. It follows from this that these level-of-detail techniques make it possible to manage only part of the description data for the terrain with the exclusion notably of the vertical faces. Thus, the current solutions based on levels of terrain detail do not make it possible to manage elements such as buildings or even simple parapet walls. In fact, this prohibits reliance on the same mechanisms for managing the terrain representation data for the management of the natural zones and for the management of the urban zones for example. This poses the following problems: the production of the terrain data and the development of the software utilizing these terrain data is particularly complex. Indeed several modes of data production and of display must be managed according to the type of data. Also, a problem of continuity arises systematically at the boundary between the relief terrain zones managed by these techniques and the zones managed by other techniques, which in general, are discrete levels-of-details techniques. Moreover, these techniques usually rely on a representation of the terrain in the form of regular grids, which are rather inefficient in terms of data compactness. This is particularly verifiable when following in a fine manner in the relief of the terrain distinctive elements which do not follow the axes of the regular grid such as hydraulic networks or road networks.

When the viewpoint moves, the degree of refinement of the data displayed may evolve locally, for example enriching the representation of the data which lie closer to the viewpoint, and degrading the representation of the data which lie distant therefrom. To avoid abrupt changes of the rendered image, recourse is then had to specific techniques to manage these transitions. One of the techniques most used within this framework is geo-morphing. A principle of geo-morphing is that when new vertices are introduced into a mesh to refine the representation of an existing zone, the new vertices are displaced progressively in such a way that the resulting surface is an intermediate representation between the starting resolution and the resolution to be attained. A drawback of geo-morphing is that it requires dynamic management of the intermediate representations. In the case where the visible part of the mesh of the relief is entirely transferred onto the graphics card at each image refresh cycle, the crux of the cost introduced by geo-morphing is related to the transfers between the main processing unit and the graphics card. In the converse case, geo-morphing requires specific processing by the graphics card, at the level of the step of processing the vertices of the mesh. Here again, in addition to a negative impact on the performance of the rendering computation by the graphics card, the impact on the complexity of the development of the rendering software can pose a problem.

As regards the updating of the data to be loaded into memory (main and graphics), to allow the display of the scene from the current viewpoint, and notably the considerations on the bandwidth required for this updating, these considerations are only very rarely tackled by the publications relating to this domain. Indeed, the various works carried out emphasize the algorithmic aspects. Though the problems related to bandwidth are mentioned in the works on clipmapping, they do not propose any concrete strategy for predicting and distributing the updates efficiently over time, for example as a function of the displacement of the centre of interest.

Another problem with current techniques is related to the strategy chosen for refreshing the rendered image, and notably to the technique for transition between the levels of detail. Indeed certain solutions involve reloading onto the graphics card a complete or partial mesh of the terrain to be displayed, doing so at each plotting cycle. In this case, the transfer of the geometric data onto the graphics card represents a non-negligible part of the cost in computation time of the final plot.

The current solutions therefore deal each time with only one of the aspects of the general problem of displaying massive terrain data in real time, with a significant risk of disturbance of the image. This considerably impairs the realism of the scenes representing the evolving training setting.

### SUMMARY OF THE INVENTION

An aim of the invention is notably to alleviate the aforementioned drawbacks. For this purpose, the subject of the invention is a method of rendering a terrain stored in a massive database the said terrain rendering being displayed for an observer by a display device comprising at least one graphics card comprising a cache memory, the said method comprising at least the following steps:
a step (81) of generating several regular grids (1, 2, 3) of different resolution level terrain patches (LOD0, LOD1, LOD2) so as to represent the terrain data of the massive database;
a step (82, 120) of extracting terrain data from the massive database for several resolution levels, the extracted terrain data forming an extraction pyramid composed of an extraction window for each level of detail, placed in cache memory;
a step (83, 9, 121) of selecting the patches of the extraction pyramid which contribute to the image;
a step (122) of plotting the rendering on the basis of the selected patches.

In a particular mode of implementation, the terrain data are extracted for several resolution levels so as to build an extraction pyramid, the said extraction pyramid consisting of a sliding extraction window for each resolution level, the said sliding extraction window being defined by an identical number of terrain patches which is fixed for all the resolution levels, the said patches extending around a position termed the position of the centre of the sliding extraction window, the said centre of the sliding extraction window evolving in real time as a function of the evolution of the position of a centre of interest, the centre of interest being determined as a function of the position of the observer with respect to the display device.

A sliding window is for example placed in cache memory, comprises an active zone intended to be displayed, and a preloading zone which makes it possible to anticipate the transfers of data.

The width of a sliding extraction window is for example defined by an even number of terrain patches.

An extraction pyramid comprising for each different resolution level a sliding extraction window consisting of a grid of patches, the spacing of displacement of the centre of a sliding extraction window of resolution level L, is for example aligned with the spacing of a grid of resolution level L+1, L being an integer, resolution level L+1 being less detailed than resolution level L.

The different resolution grids of the sliding window form for example a quaternary tree, each level of the tree corresponding to a resolution level.

The rendering of each patch of the sliding window is for example determined by traversing the quaternary tree depth-wise from the least resolved level to the most resolved level.

Each patch P of level L in intersection with the field of vision, and situated in the margin of transition of the resolution level L−1, is for example plotted by mixing the patch P with its children in the quaternary tree.

The invention has notably the main advantages of rendering a scene comprising a very extensive terrain, stored on complex visual databases with the richest possible level of detail as a function of the application of the rendering of images. Notably, the content of the image in a radius close to the observer is enriched, so as to be able to distinguish details on the elements close to the observer.

### BRIEF DESCRIPTION OF THE DRAWINGS

Other characteristics and advantages of the invention will become apparent in the description which follows, given by way of nonlimiting illustration, and offered with regard to the appended drawings which represent:

FIG. 1: an exemplary subdivision of a database into patches for several levels of details;

FIG. 2: a terrain data extraction pyramid for various levels of detail;

FIG. 3: a sliding window according to the invention;

FIG. 4a: a first position of a centre of interest;

FIG. 4b: a second position of the centre of interest;

FIG. 5: a displacement of two sliding extraction windows according to the invention;

FIG. 6: a depiction of the transition boundaries for three consecutive levels of details, corresponding to displacements of a centre of interest in a direction;

FIG. 7: a depiction of the transition boundaries in a two-dimensional space, for three consecutive levels of detail;

FIG. 8: a flowchart which decomposes the activities implemented in the method into three tasks;

FIG. 9: a flowchart for selecting the patches contributing to the rendering of the final image.

FIG. 10: an exemplary computation of a mixing coefficient for the patches for the rendering in a transition margin of a sliding extraction window;

FIG. 11: various possible states of a cell of a sliding window according to the invention;

FIG. 12: an example of managing a cache memory according to the invention.

### DETAILED DESCRIPTION

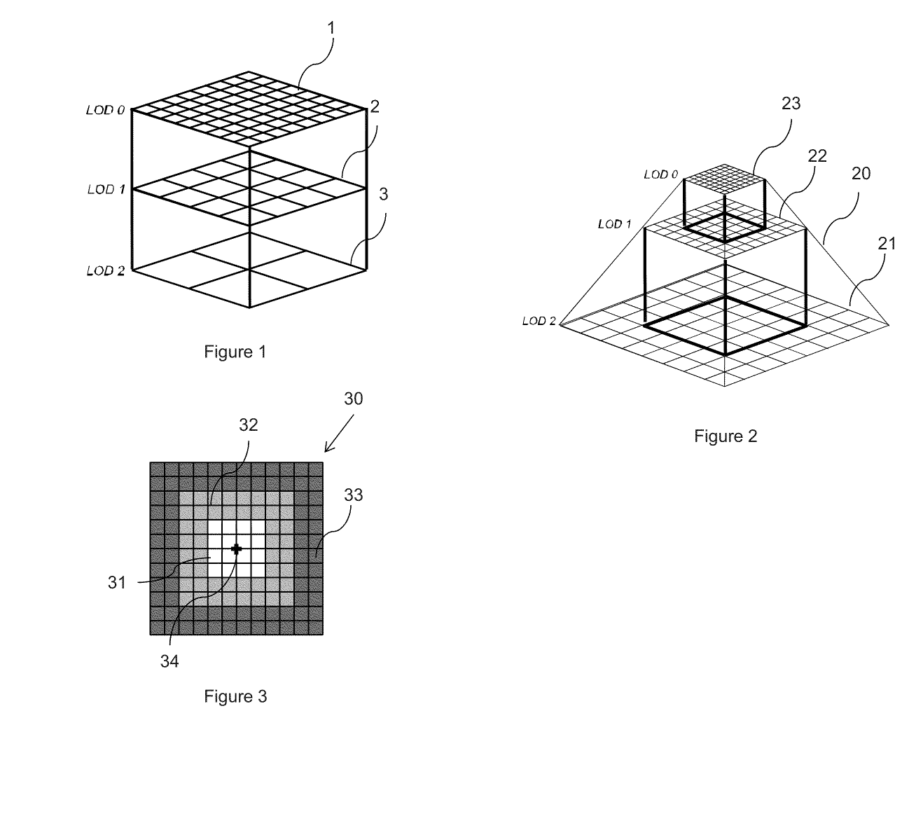

FIG. 1 represents an exemplary subdivision of a database into patches for several levels of details LOD0, LOD1, LOD2. LOD is an acronym for the expression Level Of Details.

The method according to the invention takes as input a description of terrain data stored in a massive database. The terrain data can notably be described in the database by means of one or more irregular meshes. These meshes can for example describe the relief of the terrain, as well as elements present on the terrain such as trees, buildings, highway maintenance elements, etc. A first step of the method according to the invention is a step of paving the database into tiles for several levels of different resolution. For example the paving can be analogous to the pavings used in clipmapping. The paving of the database can produce for example a first decomposition grid 1 of a terrain, for a first level of detail LOD0. The first grid 1 can be a square grid comprising eight rows and eight columns such as represented in FIG. 1 in respect of the example. Each patch of this grid contains the description of the data of the corresponding portion of terrain, for example in the form of irregular triangular meshes. A second grid 2 represents the same terrain as the first grid 1, for a level of detail LOD1 less than the level of detail LOD0. For example, this second grid 2 can comprise four rows and four columns. The content of each patch of the grid 2 consists of data representing the terrain in a coarser manner than at the level LOD0. For example, the meshes contained in each patch of the grid can correspond to simplified versions of the meshes representing the original terrain. A third grid 3 representing the same terrain can comprise two rows and two columns. The third grid 3 has a level of detail LOD2, less than the level of detail LOD1, and than the level of detail LOD0. The level of detail LOD2 is the coarsest level of detail in the example. For greater clarity, FIG. 1 presents grids comprising relatively few cells. In practice, it will be possible for example to subdivide the database with a view to obtaining patches with a length of side of the order of a kilometre at the most resolved level. The number of cells of the grid will then depend on the total extent of the database, which may exceed several thousand kilometres.

The generation of grids of various resolution levels is performed upstream of the method according to the invention so as not to integrate any terrain data simplifying process into a method of terrain display. Thus, it is also advantageous not to impose any constraint on the representation of the input data of the method according to the invention. In particular, urban zones can be readily integrated into the data taken into account by the method according to the invention.

Advantageously, the use of arbitrary triangular meshes for the patches of the massive database allows great flexibility in the production of massive terrain databases. For example, on the basis of a level of detail specified by configuration, it is possible to exclude from the content of the patches the meshes corresponding to certain types of buildings.

A first step of the rendering method according to the invention, can be a step of preprocessing the data of the terrain database. In the course of this first preprocessing step, several representations of the terrain database can be generated, each for a different level of detail. Various resolutions of data are notably represented in FIG. 1. The first step of the rendering method may be carried out just once for various iterations of the rendering computation.

In the subsequent description, by convention, the levels of details LOD are numbered by decreasing resolution. Stated otherwise, level LOD0 corresponds to the most precise level of detail, level LOD1 corresponds to a coarser level of detail than level of detail LOD0, and so on and so forth. For each level of detail, the terrain data can be subdivided according to a regular grid of patches or tiles. For example, the spacing of the grid can be doubled between a grid of a level of detail L, L being an integer, and a less resolved level of detail L−1. Thus, the paving of the database can be organized in such a way that each patch of a grid of level of detail L, is a simplified version of a union of four adjacent patches of the grid of level L−1. Thus, each patch of a level L−1 can be associated with the root node of a quaternary tree, or quadtree of the level L. For each patch associated with a node of the quadtree, four children can each represent a quarter of the parent patch, with a higher resolution than that of the parent patch.

FIG. 2 represents an example of a terrain data extraction pyramid 20 for several different levels of details LOD0, LOD1, LOD2. By using a slicing into levels of details, analogous to the one represented in FIG. 1, a mechanism for extracting terrain data from the massive database can be put in place. An extraction distance can vary as a function of the level of detail. An extraction distance represents an extent of the terrain data extracted for a defined level of detail, that is to say for example loaded from an external device for storing the database to the main and graphics memories of the simulation system, so as to be able to be utilized in real time for display. For example, in FIG. 2, a base 21 of the extraction pyramid 20 represents a terrain extraction for a level of detail LOD2. For example, such as represented in FIG. 2, the size of the terrain data extracted for the level of detail LOD2 is a square of eight rows by eight columns. This square corresponds to a subset of the matrix formed by the paving of the whole of the database for this level of detail. An intermediate level 22 of the extraction pyramid 20 corresponds to the terrain data extracted for a level of detail LOD1. In FIG. 2, the intermediate level 22 comprises terrain data distributed over a square comprising eight rows and eight columns. Thereafter, a higher level 23 of the extraction pyramid 20 corresponds to terrain data extracted for a level of detail LOD0. The geographical correspondence between the extractions of the various levels is depicted as bold lines by the projection of each extraction onto that of the next level.

The extraction method can be based on the following strategy: for each level of detail LODn, a sliding window of patches, which is centred on an extraction point, is updated with part of the patches of the database for the level of detail LODn. The sliding window associated with a level of detail is represented in FIG. 3. The extraction pyramid 20 represented in FIG. 2 thus consists of the set of sliding windows 23, 22 and 21, associated respectively with the levels LOD0, LOD1 and LOD2. The width of the sliding windows 21, 22, 23, that is to say the number of patches defining their size, is the same for all the levels of detail LOD0, LOD1, LOD2. In FIG. 2, the number of patch is eight for the example. As a patch of a mesh of level L+1 is twice as large as a patch of a mesh of level L, the extraction distance between two consecutive levels of details is therefore doubled in this example. The sliding extraction window is named clipwindow hereinafter, an expression signifying literally slice window.

FIG. 3 represents a clipwindow 30 according to the invention. A clipwindow 30 is associated with each level of detail L, and comprises a subset of the patches defined for this level in the terrain database. A clipwindow 30 according to the invention comprises three distinct zones 31, 32, 33 centred on a point 34 named the clipcenter 34. Clipcenter is an expression that may be regarded as equivalent to slice centre. The clipwindow 30 therefore comprises: a central zone 31, a transition zone or margin 32, a preloading zone or margin 33.

The central zone 31 and the transition zone 32 form a zone named the active zone of the clipwindow 30. The active zone 31, 32 is displayed for the terrain rendering according to the invention. The preloading margin 33 is not displayed: it is used to place in cache memory, in a predictive manner, patches of the clipwindow 30 having a chance of entering the active zone 31, 32 in the short term.

To facilitate the management of the problems of continuity between the clipwindows of two different levels of detail, the spacing of the grid corresponding to level L+1 can be aligned with the spacing of the grid corresponding to level L. Thus, the management of the discontinuity between the clipwindows 30 advantageously amounts to guaranteeing the continuity at the boundary between a patch of level L and its direct neighbours in the level L−1. To ensure this alignment, the width of the clipwindow comprises an even number of patches. The clipcenter 34 can be defined by integer coordinates in two dimensions, which correspond to the indices of a patch in the matrix formed by the terrain database regular paving grid for the associated level of detail. The patch in question can for example be that whose bottom left corner corresponds to the centre of the clipwindow 30. To comply with the alignment constraints, the coordinates of the clipcenter 34 are therefore even numbers in the example presented.

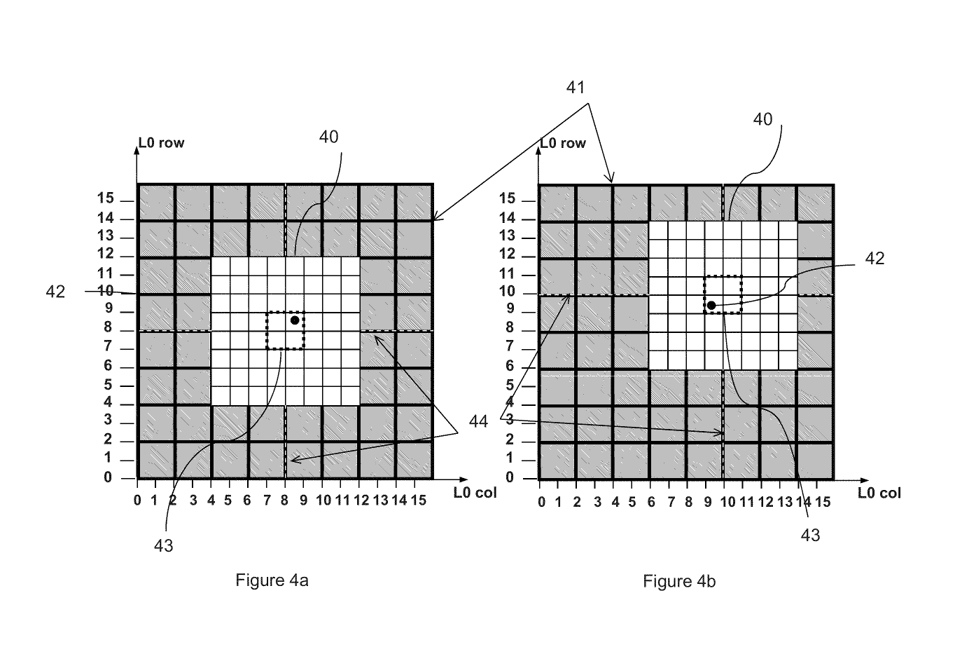

FIGS. 4a and 4b illustrate the alignment of a clipwindow 40, associated with a level of detail L, on the paving grid 41 defined in the database for the level of detail L+1. In particular, they show the impact of the displacements of the centre of interest 42 on the indices of the clipcenter, depicted by the white dashed cross 44. In the example, the level of detail L is depicted by L0, and the indices of the patches of the grid for this level are labelled on the axes “L0 col” and “L0 row”. The even indices of the paving 41 are depicted by a thick black cross-ruling. The latter coincides with the grid formed by the paving of the level of detail L+1. In FIG. 4a, the zone 43 in which the centre of interest can evolve, without this translating into a change of the clipcenter indices, is depicted by thick black dots. In FIG. 4a, the clipcenter position 44 can be defined by the indices of the patch whose bottom left corner is at the centre of the clipwindow: [8; 8]. These indices are the even indices for which the position 44 of the clipcenter is closest to the centre of interest 42. The position of the centre of interest 42 can for example be related to the position of an observer in the scene. The position of the centre of interest 42 can be slaved to the displacement of the observer, or to the displacement of his gaze on the image for example.

In FIG. 4b, following a displacement of the centre of interest, the new indices of the clipcenter 44 are [10, 10], that is to say the even indices of the patch whose bottom left corner is closest to the centre of interest 42. Accordingly, in FIG. 4b, the clipwindow 40 is shifted so as to remain centred on its clipcenter 44. The new zone 43 in which the centre of interest can evolve without entailing any displacement the of clipwindow 40 is depicted again.

FIG. 5 represents displacements of two clipwindows 50, 52 of two successive levels of details, respectively L and L+1. The respective centres of these two clipwindows are represented respectively by the points 51 and 53. The displacement of the clipwindows 50, 51 follows a displacement of the centre of interest, for example along a first axis 500, substantially parallel to one of the two terrain database paving axes in the example. In the course of a first step 0, the first and second clipcenters 51, 53, respectively of the first and second clipwindows 50, 52 are at one and the same position. In the course of a second step 1, the first clipcenter 51 moves along the first axis 500, and the first clipwindow 50 with it, so as to follow a displacement of the centre of interest. The first and second clipcenters 51, 53 are then no longer merged. In the course of a third step 2, the second clipcenter 53 and the second clipwindow 52 move along the first axis 500. The displacement effected in the course of the third step 2 is a displacement over a distance twice as large as the movement of the first step 1, indeed, there exists between the two grid spacings of the two clipwindows 50, 52, a multiplicative factor of two in this example. After the displacement of the third step 2, the second clipcenter 53 lies above the first clipcenter 51. On completion of the third step 2, the distance between the first and the second clipcenter 51, 53 is the same as on completion of the second step 1. In the course of a fourth step 3, the second clipwindow 52 moves further along the first axis 500, upwards, in such a way that the first clipcenter 51 is at the same position as the second clipcenter 53.

Generally, a computation of the position of a clipcenter, by rounding of the position of the centre of interest on the grid of higher level such as represented in FIGS. 4a, 4b, uniquely defines the transitions of a clipwindow: that is to say the boundaries which, when the centre of interest passes through them, give rise to a displacement of the clipcenter, and therefore of the clipwindow. They may be named “transition boundaries”. Thus each time that the centre of interest crosses one of the transition boundaries, the clipcenter moves with its clipwindow. New patches then enter the clipwindow preloading zone. These new patches are extracted from the database, and transferred to the cache memory allocated for the clipwindow. Likewise patches exit the preloading zone, they are then released from the cache memory.

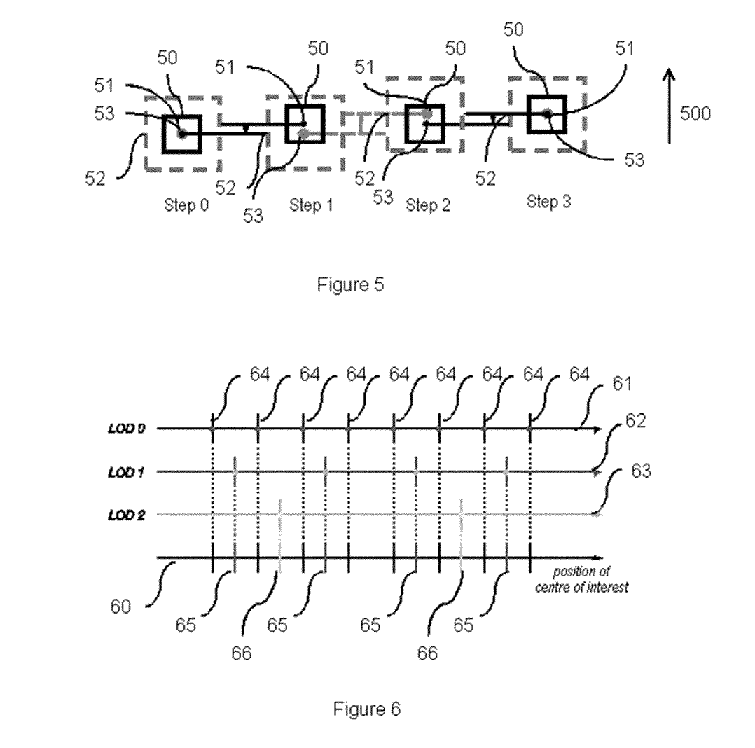

FIG. 6 illustrates the relations between the transition boundaries corresponding to the clipwindows of three consecutive levels of details LOD0, LOD1, LOD2 as a function of displacements of the centre of interest. For the example the centre of interest moves parallel to one of the axes of the grids for subdivision into levels of details of the terrain database. In the example represented in FIG. 6, the most resolved level of detail is the level LOD0 whereas the least resolved level is the level LOD2. In FIG. 6, the displacement of the centre of interest is performed along a first axis 60. The displacements of the clipcenters of the clipwindows relating to each level of detail are effected in a manner parallel to the displacement of the centre of interest, with a progression spacing proportional to the spacing of each level of detail grid. The displacements of the clipcenters for each level of detail LOD0, LOD1, LOD2 are represented respectively by horizontal arrows 61, 62, 63. The vertical lines in FIG. 6 represent the transition boundaries 64, 65, 66 respectively for each level of detail LOD0, LOD1, LOD2, along the displacement of the centre of interest. The transition boundaries of the level of detail LOD0 coincide with the centres of the patches of the following less resolved level of detail, that is to say in the example represented the level of detail LOD1. Therefore, in the example represented in FIG. 6, first transition boundaries 64 corresponding to the level of detail LOD0 are spaced half as far apart as second transition boundaries 65 of the less resolved level of detail LOD1. Likewise, the second boundaries of LOD1 are spaced half as far apart as third transition boundaries 66 of the least resolved level of detail LOD2. Under these conditions, when the centre of interest moves parallel to an axis of subdivision of the terrain data, it may be demonstrated that a minimum distance between two transition boundaries of a level is equal to the size of a patch of the most resolved level.

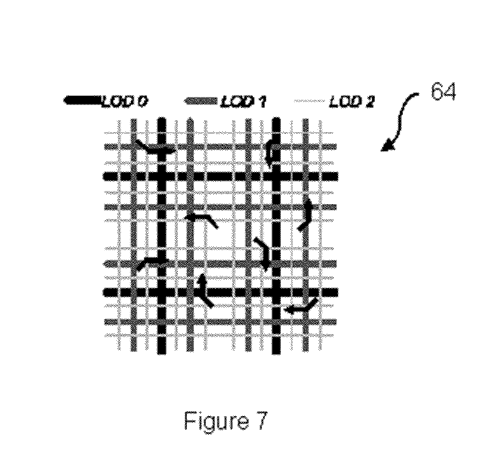

FIG. 7 represents in a more general manner transition boundaries in a two-dimensional space 64, for three consecutive levels of detail LOD0, LOD1, LOD2. FIG. 7 therefore represents a generalization of the representation of the transition boundaries, such as are represented in FIG. 6, to arbitrary displacements of the point of interest in the two-dimensional space 64, in which the terrain database has been subdivided into grids. FIG. 7 represents notably a superposition of the three grids LOD0, LOD1, LOD2. The displacement of the centre of interest is represented by arrows in the space subdivision composed of the pavings relating to the three distinct levels of detail. The displacements of the centre of interest are such that the centre of interest passes through at most two transition boundaries simultaneously: a horizontal transition boundary and a vertical transition boundary. An intersection between a horizontal boundary and a vertical boundary is named a transition point. Starting from a transition point, the shortest path such that the centre of interest reaches another transition corresponds to a displacement of the centre of interest along one of the axes of subdivision of the database. Advantageously, it is therefore possible to reduce to a transition in one dimension such as represented in FIG. 6. By the same token, if resources are allocated that are sufficient in terms of bandwidth to be able to update two clipwindows in conjunction with one and the same transition point, in less time than that taken by the centre of interest to traverse a distance equal to the size of a side of a patch of the most resolved level of detail, in our case LOD0, then it may be guaranteed that it will always be possible to keep the extraction pyramid updated during the displacements of the centre of interest. For example, if an upper bound on the speed of displacement of the centre of interest is available as input, it is possible to deduce therefrom an upper bound of the bandwidth required to keep the set of clipwindows updated whatever the displacements of the observer.

The width of a clipwindow is denoted by w, and the width of the preloading margin is denoted by b, in terms of number of patches. During the passage of a vertical or horizontal transition, the number of patches to be extracted to update the clipwindow is b×w. For a transition point situated at an intersection of two transition boundaries, involving two clipwindows of different levels of details, the number of patches to be reloaded is 2×b×w. Let K be the maximum cost of transfer for a patch from the database, the bandwidth can be dimensioned so as to allow the transfer of a quantity of data equal to 2×b×w×K. These data must be able to be transferred in a duration of less than or equal to the time taken by the centre of interest to traverse a distance equal to the size d of a side of a patch of the most resolved level of detail, for example LOD0 in the example represented in FIG. 7. A speed named Vₘₐₓ is a maximum speed of displacement of the centre of interest. The duration of the displacement can therefore be expressed by the following formula: d/Vₘₐₓ. By taking the ratio of the quantity of data to be transferred for such a transition, to the minimum time available for the transfer, it is therefore possible to express the bandwidth BW required thus:

$$BW ( {V}_{max} ) = \frac{2 \times b \times w \times K}{d} {V}_{max} . \qquad ( 1000 )$$

Advantageously, the use of equation (1000) makes it possible to obtain a behaviour of the predictive loading of the data of the database and thus to use the available bandwidth in the most efficient manner.

Thus, the use of a predictive cache comprising the patches of the clipwindows preloading zones makes it possible to simply dimension the hardware used to meet specific needs of a case of use of the rendering method according to the invention. Reciprocally, the use of the predictive cache makes it possible to adapt data production to satisfy constraints in terms of bandwidth which relate to a given hardware for the implementation of the method according to the invention.

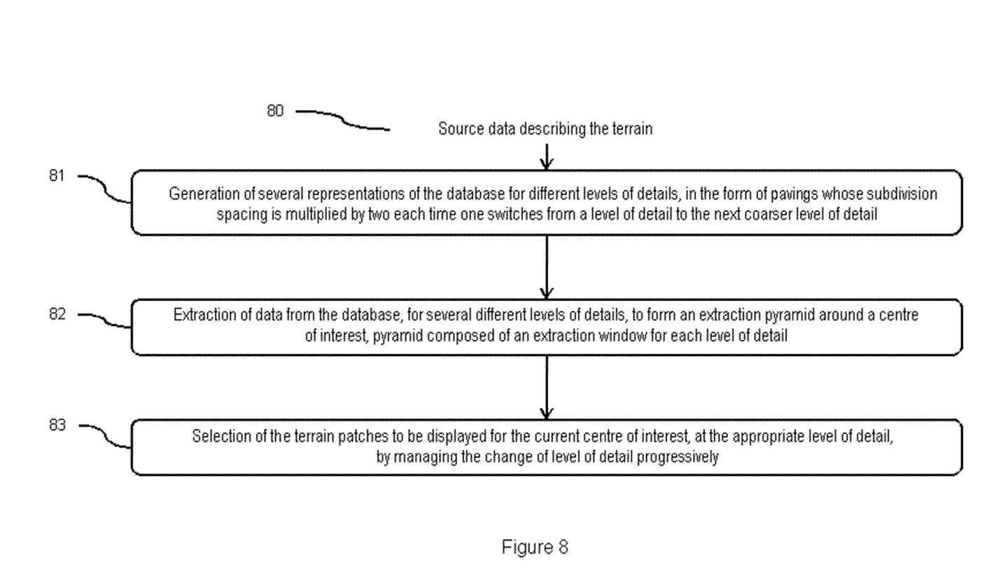

FIG. 8 represents a flowchart which decomposes the activities implemented in the method into three tasks. The source data 80 describing the terrain constitute the input data of the method. These data consist for example of image data, of geometric data describing the surface of the terrain, or else of three-dimensional type objects, modelled by external tools, and positioned in the database. The geometric description data can notably be arbitrary irregular triangular meshes. A step prior to the rendering computation is a generation 81 of several representations of the database for different levels of details. This generation consists notably in organizing the source data for each level of detail, by distributing them in a grid, to form a paving such as described in FIG. 1. The generation may be carried out just once for several iterations of the rendering computation. For example, the result of the generation can be computed for the whole of the terrain, and then stored on a persistent storage system, so as to be accessed directly by the component in charge of the rendering. An alternative consists in putting in place a server producing the terrain patches on demand on the basis of the source data.

Upon the execution of the system, when the point of interest passes through a transition boundary such as described hereinabove, the system performs in the course of a second step 82 an extraction of patches, on the basis of the database, for several different levels of details. The extracted patches form an extraction pyramid. The extraction pyramid is composed of a sliding extraction window or clipwindow for each level of details, each sliding window comprising the same number of patches. The result of this activity is the updating of a data cache, which makes it possible to transfer in a predictive manner the data potentially necessary for display.

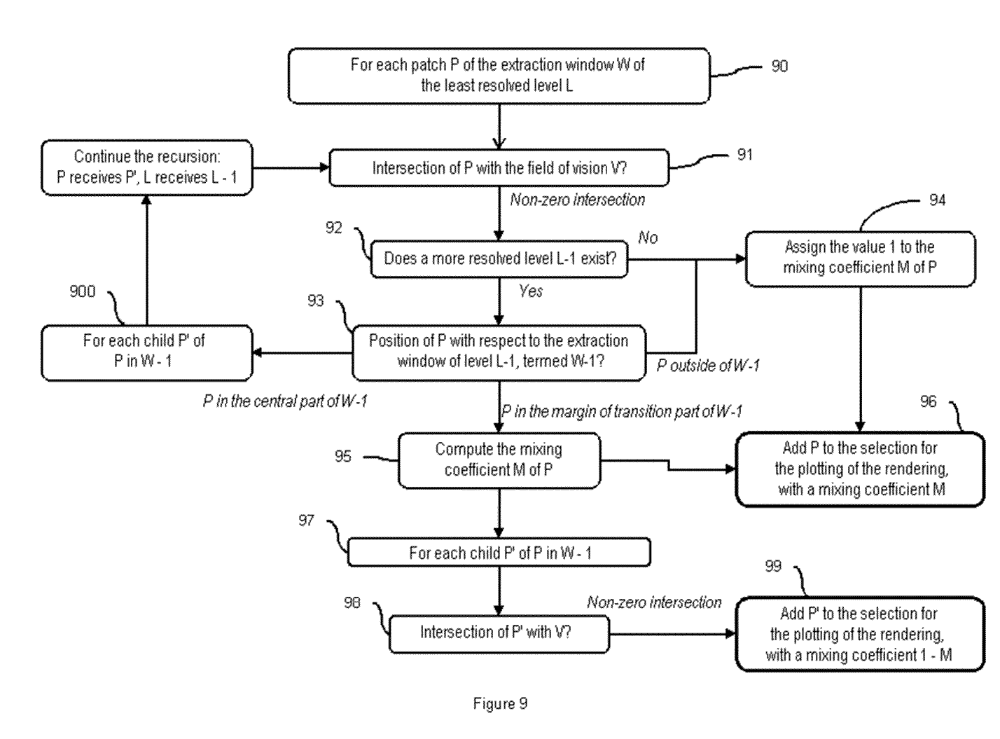

A third step 83 consists in selecting, from among the patches present in cache memory, those which will contribute to the rendering of the image. This selection consists notably in determining the patches visible from the current viewpoint, and in selecting the appropriate level of detail, so as to display the content most suited to the viewpoint. A selection algorithm according to the invention is described in the flowchart of FIG. 9.

FIG. 9 represents a flowchart for selecting the patches contributing to the rendering of the final image. The patches of the clipwindows corresponding to the least resolved level of detail are considered first. For each of these patches, the processings described below are carried out. Hereinafter, the current patch is denoted P, the current clipwindow is denoted W, and the current level of detail is denoted L.

Therefore for each patch P, its intersection with the field of vision V corresponding to the current position of the observer is computed in the course of a step 91. The computation can be done in a conservative manner, by considering the intersection of a volume encompassing the patch with the various planes of the field of vision.

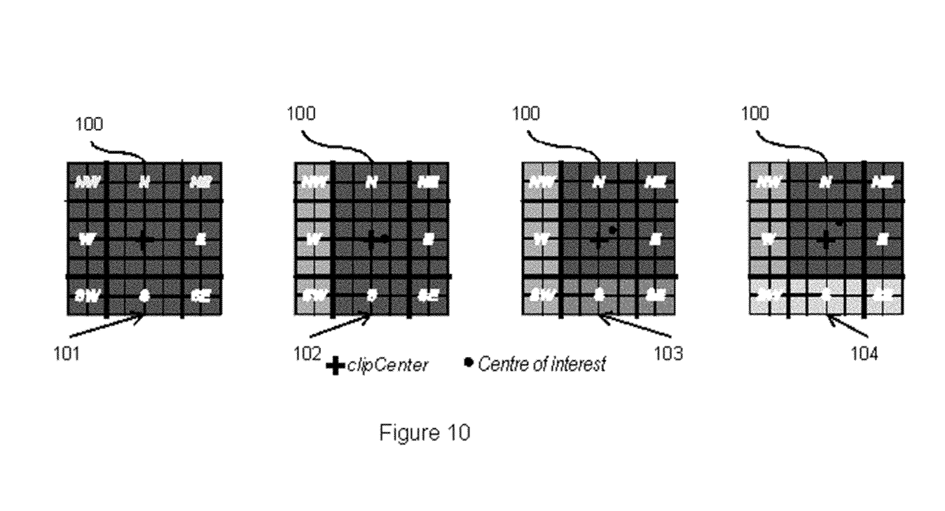

If the intersection of P with the field of vision is zero, the current patch P is excluded from the selection for the image in progress, and step 90 switches to the following patch. Otherwise, the algorithm switches to step 92, and verifies whether a more resolved level of detail exists. If the current level of detail L is the highest level, the patch P undergoing processing is directly added to the set of patches to be plotted. Otherwise, the relative position of P with respect to the clipwindow W−1 of level L−1 is considered. The comparison is a third step 94 of the method according to the invention, such as represented in FIG. 10.

When P is in the central part of W−1, the method according to the invention then performs an iteration on each of the children of P in the extraction pyramid, by implementing step 91 and the following steps on each of the children.

When P is outside W−1, then the patch P is directly selected for the rendering in the course of step 96.

When P is in the transition margin of W−1, the plotting of P for the rendering is carried out in the course of steps 95 to 99. The plotting of P is carried out in this case by mixing by transparency the patch P with the child patches of the patch P which have a non-zero intersection with the field of vision, the transparency being dependent on a mixing coefficient. The mixing is performed such as represented in FIG. 10.

FIG. 10 represents a clipwindow 100 as well as its clipcenter, represented by a cross, and a centre of interest represented by a point, the said centre of interest moving with respect to the clipcenter. The transition zone of the clipcenter is divided into several sub-zones dubbed by a cardinality: NW for North-West, N for North, NE for North-East, E for East, SE for South-East, S for South, SW for South-West, and W for West. For each of the eight sub-zones, a mixing coefficient is computed as a function notably of the position of the centre of interest.

On a first representation 101 of the clipwindow 100, the centre of interest and the clipCenter are merged, the mixing coefficient is then equal to 1, all the transition zone patches are therefore represented without transparency.

On a second representation 102 of the clipwindow 100, the centre of interest has moved eastwards with respect to the clipCenter. A first transparency coefficient is therefore applied to the sub-zones NW, W and SW. If the patches of these sub-zones are selected for the rendering, the transparency coefficient computed will be used to mix them with the corresponding parent patches in the following level of detail. All the patches of the other sub-zones of the transition zone are assigned a coefficient of 1, this signifying that they will be represented without transparency if they are selected for the rendering.

On a third representation 103 of the clipwindow 100, the centre of interest has shifted Northwards with respect to its position in the representation 102. The first coefficient is still applied to the patches of the sub-zones NW, and W, and a second transparency coefficient is applied to the patches of the sub-zones S and SE. The patches of the sub-zone SW are assigned the minimum value of these two coefficients. The other sub-zones are again assigned a coefficient of 1.

On a fourth representation 104 of the clipwindow 100, the centre of interest has again moved Northwards with respect to the representation 103. The transparency coefficient computed for the sub-zones S and SE then becomes less than that computed for the sub-zones W and NW. It follows from this that the sub-zone SW is assigned the coefficient value of the sub-zone S, and no longer that of the sub-zone W.

The mixing coefficient can be computed in the following manner: let focusPoint be a position of the centre of interest, defined by its coordinates in the two main dimensions of the database. According to the convention chosen for the paving of the database, this may involve for example a pair x, y in a plane chosen for the subdivision, or else a pair (latitude, longitude). For a level of detail, integer coordinates clipCenter of the clipcenter corresponding to the position of the centre of interest can be given by the following equation:

$$[ clipCenter ] = 2 ⌊ \frac{1}{2 d} [ focusPoint ] + [ \begin{matrix}0.5 \\ 0.5\end{matrix} ] ⌋ . \qquad ( 1001 )$$

In equation 1001, d represents the size of a side of a patch for the level of detail considered. The symbols └ ┘ correspond to the “integer part” operator. These coordinates therefore correspond to the even indices of a patch in the matrix formed by the paving of the level of detail considered. The patch in question is the patch of even indices whose bottom left corner is closest to the centre of interest.
The rounding error, which conveys the difference between the position of the centre of interest and the position of clipCenter, can be computed in the following manner:

$$rndErr = [ \begin{matrix}{rndErr}_{x} \\ {rndErr}_{y}\end{matrix} ] = d \cdot [ clipCenter ] - [ focusPoint ] . \qquad ( 1002 )$$

On the basis of the rounding error, it is possible to determine a mixing coefficient blend for each level of detail and for each zone of the transition margin:

$${blend}_{w} = \{ \begin{matrix}\frac{1 - {rndErr}_{x}}{1 - blendThreshold} & if {rndErr}_{x} > + blendThreshold \\ 1 & otherwise\end{matrix} \\ {blend}_{W} = \{ \begin{matrix}\frac{1 + {rndErr}_{x}}{1 - blendThreshold} & if {rndErr}_{x} < - blendThreshold \\ 1 & otherwise\end{matrix} \\ {blend}_{S} = \{ \begin{matrix}\frac{1 - {rndErr}_{y}}{1 - blendThreshold} & if {rndErr}_{y} > + blendThreshold \\ 1 & otherwise\end{matrix} \\ {blend}_{N} = \{ \begin{matrix}\frac{1 + {rndErr}_{yx}}{1 - blendThreshold} & if {rndErr}_{y} < - blendThreshold \\ 1 & otherwise\end{matrix} \\ {blend}_{SW} = min ( {blend}_{W} ; {blend}_{S} ) \\ {blend}_{SE} = min ( {blend}_{S} ; {blend}_{E} ) \\ {blend}_{NE} = min ( {blend}_{E} ; {blend}_{N} ) \\ {blend}_{NW} = min ( {blend}_{N} ; {blend}_{W} ) \qquad ( 1003 )$$

In formula 1003, blendThreshold is a threshold value, which fixes in each direction (W-E and S-N) the value of the error on the basis of which one begins to mix the patches of the transition zone with their parents of coarser level of detail. It is possible to determine this value through the formula:

$$blendTreshold ( L ) = max ( userThreshold ; [ 1 - \frac{userThreshold}{{2}^{lodsCnt - 1 - L}} ] ) \qquad ( 1004 )$$

in which lodsCnt is the total number of levels of detail generated for the database, L is the level of detail considered, and userThreshold is a constant fixed by configuration at a value lying between zero and one.

Advantageously, the transitions obtained during the changes of resolution following the displacement of the centre of interest are then soft transitions. Just as for the preloading strategy represented in FIGS. 4a, 4b, the transitions depend only on the position of the centre of interest and possess the same characteristics.

The management of the progressive transition between an image in which patches of a first level of detail are displayed, and an image in which these patches are replaced by their parents of the following coarser level of detail, is performed by a transparency set on the terrain display screen.

Advantageously, the transitions are applied to a finite number of patches, thereby making it possible to predict the cost overhead related to the mixing of patches during these transient phases. Thus, the spikes in plotting time that are related to uncontrolled transitions are avoided, and it becomes possible to tailor the richness of the levels of detail generated so as to guarantee a constant image refresh rate.

Advantageously, the choice of a transition by image transparency eliminates the constraints specific to geo-morphing and makes it possible to use a static mesh of the terrain on the graphics card. Thus, the cost overhead due to using several levels of details is limited. Just the mixing of the zones undergoing transition uses additional computation time with respect to conventional rendering. Outside of the zones undergoing transition, the use of the levels-of-detail technique does not have any impact on the performance of the graphical display.

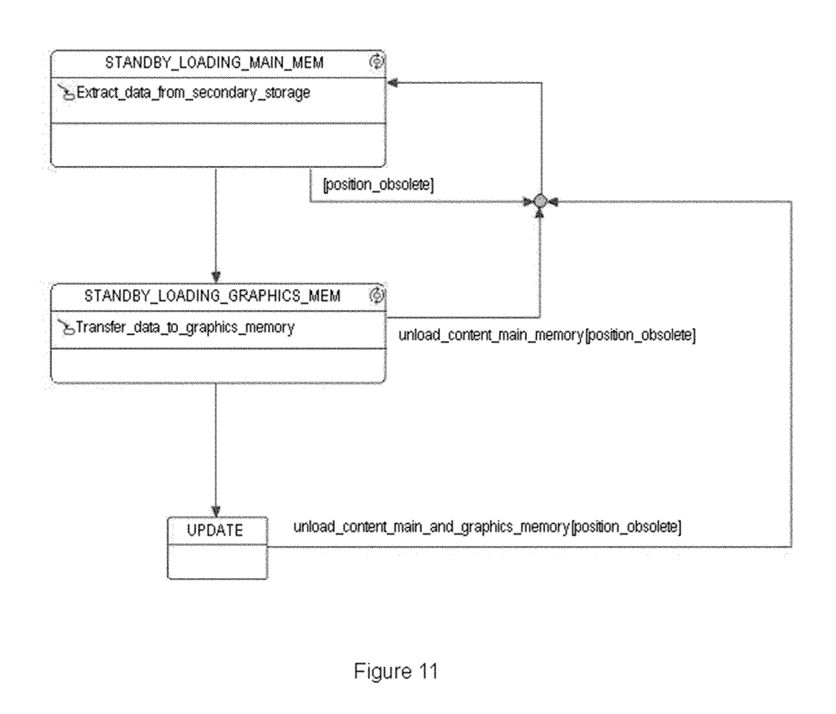

FIG. 11 represents various states that can be taken by a cell of a sliding window. As described hereinabove, for each patch of the sliding window, the passage from a resolution level L to a more precise resolution level L−1 is done by mixing the patch with its four child patches, that is to say with the four patches corresponding of the level of detail L−1. For proper operation of the predictive cache, the four child patches are in one and the same state at the same instant. The four child patches therefore form a coherent group that may be referred to by the term cell. A sliding window of each cache level can then be described as a matrix of cells, in which each cell groups together four patches. The cell is characterized by the indices of its bottom left patch. In this example the said indices are even and can be referred to by the following expression: “reference position of the cell”. On the basis of the centre of interest of the sliding window and of its width, the set of reference positions that are valid for all the cells of the sliding window can be computed. Each valid reference position can be assigned to one and only one entry of the matrix of cells by using for example a modulo operator on each of the two indices of the cell. Thus, the management of the cache of cells reduces, for each sliding window of a level of detail, to updating the content of the cells as a function of the evolution of their reference position. The various states of a cell as well as the transitions between these various states are represented in FIG. 11.

A first state can be the STANDBY_LOADING_MAIN_MEM state. This state signifies that the cell is in a standby state awaiting loading into a main memory of the rendering computation system. The content of the cell corresponding to the current reference position is therefore on standby awaiting its transfer from a secondary storage device, to a main memory of the rendering computation device. A secondary storage device can be a hard disc, a network store. The transfer of data from a secondary memory to the main memory is implemented by a first function: Extract_data_from_secondary_storage. A cell switches to the STANDBY_LOADING_MAIN_MEM state when its current reference position is modified: in this case, the position of the cell becomes obsolete. The current position that has become obsolete is represented in FIG. 9 by [position_obsolete]. In the latter case, the data associated with the new position of the cell are extracted from the secondary storage device to the main memory. Moreover, as a function of a previous state of the cell, the content corresponding to the previous reference position can be unloaded from the main memory and from the graphics memory. If the reference position is still valid, once the data have been extracted, the cell switches to a second state: STANDBY_LOADING_GRAPHICS_MEM. Otherwise, the cell remains in the STANDBY_LOADING_MAIN_MEM state so as to be able subsequently to undertake an extraction of the data corresponding to a new reference position. The STANDBY_LOADING_GRAPHICS_MEM state signifies that the cell is on standby waiting to be loaded into a graphics memory of the rendering device.

When the cell is in the second STANDBY_LOADING_GRAPHICS_MEM state, the content of the cell corresponding to the current reference position is present in the main memory; it is on standby waiting to be transferred to the graphics memory. The action of transfer to the graphics memory is represented in FIG. 11 by the function Tranfer_data_to_graphics_memory. A cell switches to the second state when the data associated with its current reference position have been extracted successfully. If the reference position is still valid once the data has been transferred to the graphics memory, the cell switches to a third state: “UPDATE” signifying that the current reference position updated. Otherwise during the loading of a reference position, the cell switches back to the STANDBY_LOADING_MAIN_MEM state, and the data associated with the previous reference position are released. The releasing of the data can be carried out by the function unload_main_memory_content [position_obsolete].

When the cell is in the third UPDATE state, the content corresponding to the current reference position is present in main memory and in graphics memory: all the patches of the cell can therefore be plotted. A cell switches to the UPDATE state when the data associated with its current reference position have been successfully transferred to the graphics memory. The cell then remains in the UPDATE state as long as the reference position of the cell remains unchanged. When the reference position of the cell changes, then the cell switches back to the STANDBY_LOADING_MAIN_MEM state, and the data associated with the previous position that has become obsolete are released from the main memory and from the graphics memory for example by the following function: unload_main_and_graphics_memory_content [position_obsolete].

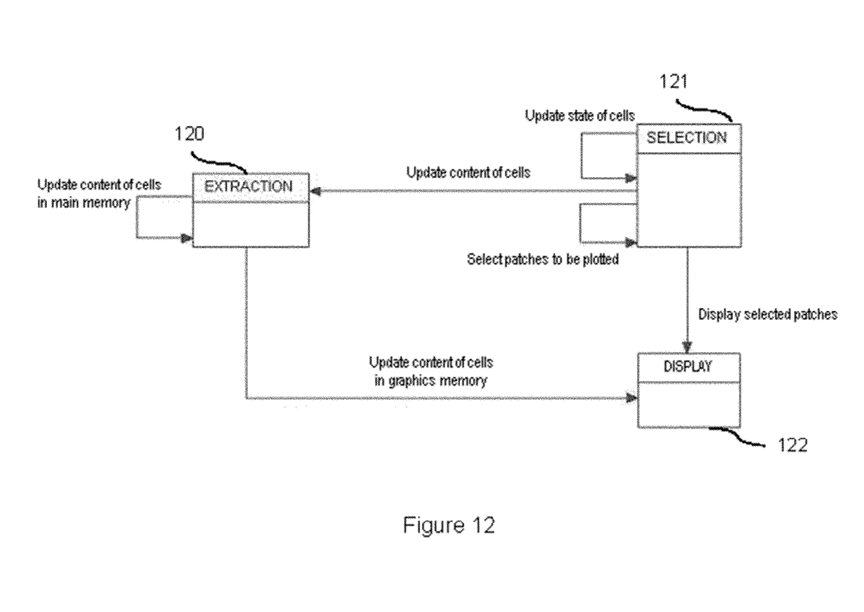

FIG. 12 represents a management of a cache memory in a predictive manner according to the invention. Hereinafter the cache memory is called a predictive cache. Advantageously, decomposing the management of the cache memory according to three distinct tasks, such as is described below, makes it possible to guarantee a stable refresh cycle for the display device. Indeed, such management of the cache memory makes it possible to reduce the impact of the transfer of data, in the course of a display cycle, on the refresh rate for the image displayed during the rendering. The decomposition into tasks of the management of the predictive cache is manifested in the rendering system by the implementation of lightweight processes, customarily called threads. The management of the predictive cache can comprise three tasks relating to: the display of the terrain, the selection of the cells to be displayed, the extraction of terrain data for the updating of the cells.

A first task can be named DISPLAY. The DISPLAY task is a task centralizing the communications with a driver of the graphics card. The DISPLAY task is principally charged with transmitting to the driver of the graphics card requests to plot the patches of the database that are visible by referring to the current centre of interest. The DISPLAY task is also responsible for transmitting requests for data transfers on the graphics card. The display task is generally clocked by a vertical synchronization of the display system. In most cases, the clocking is carried out at an execution frequency of the order of sixty hertz. In order to limit the impact of the transfers on the time for processing a plot by the graphics card, a transfer budget per cycle can be assigned to the DISPLAY task. The cells on standby awaiting loading to the graphics memory can be inserted into a refresh queue. The refresh queue is traversed at each refresh cycle by the display task. For a given cycle, the traversal of the refresh queue stops when the transfer budget allocated to the task is consumed.

A second task can be a selection task, named SELECTION in FIG. 10. The objective of the selection task is to take into account so-called application events such as displacements of the observer. The selection task also performs the updates ensuing from the change of status of the cells in the predictive cache. Notably, the selection task carries out for example the following function: Update the status of the cells. For the cells whose content has become obsolete, queries can be transmitted to a third extraction task. For example: Update the content of the cells. The selection task traverses the set of updated cells and selects from each cell traversed the patches to be plotted, at the appropriate level of detail, such as represented in FIG. 9, by running the rendering method according to the invention. Like the display task, the selection task is clocked on the vertical synchronization.

A third task can be an extraction task, named EXTRACTION in FIG. 10. The job of the extraction task is notably to update the content of the cells in the main memory. More precisely, when the reference position of a cell has changed, the extraction task:
loads the content associated with the new reference position;
replaces the content corresponding to the former reference position of the cell, with that corresponding to the new reference position;
unloads the content corresponding to the former reference position.
   By centralizing the cell content updates in an asynchronous processing, the extraction task makes it possible for the synchronous tasks of selection and display not to be disabled by the updating of the cells, and in particular by the transfers of content from the secondary storage devices. For reasons of performance on current platforms, the communications with the driver of the graphics card being centralized by the display task, the extraction task communicates with the display task to transfer/release the content of the cells on the graphics card. As a function of the number of processors available on the central unit of the rendering system, the extraction task can be manifested by several threads, each simultaneously handling the processing of part of the cells on standby awaiting extraction.

The invention relies notably on two principles: a principle of memory management and a principle of terrain representation.

Advantageously, these two principles according to the invention make it possible to guarantee fluidity in the display of the successive images while ensuring soft transitions, that is to say hardly visible to the human eye, between the various levels of detail represented. Thus, when a terrain zone, previously displayed with a coarse level of detail switches to a display with a more detailed level, the transition is hardly visible to an observer of the image.

The invention makes it possible advantageously to raise the performance of the terrain rendering system by optimizing the computation resources required for the rendering computation, without degrading the quality of the image. Indeed, the invention simultaneously makes it possible:
to appreciably increase the terrain visibility distance for an observer, or to see very far;
to enrich the content of the image in a radius close to the observer, for example to distinguish blades of grass, without however this being perceptible to the image.

The refreshing is advantageously sufficiently reactive to allow the observer to move at the speed that he desires in the rendered scene, without the display device lacking any data for displaying the image at the desired resolution.

Advantageously, and against the trend of current technical solutions, the invention proposes an approach relying on simple techniques of levels of discrete detail, as well as on a clever organization of the database of the images to be produced, allowing optimal management of the memory footprint and of the bandwidth. Indeed, the implementation of a predictive cache to transfer the patches required for display as a function of the position of the centre of interest makes it possible to distribute the data transfers optimally for the various levels of detail. In a more general manner, the method according to the invention uses the flexibility of the discrete levels of detail but with a both very weak and bounded impact on the performance and use of the memory.

Advantageously, the restrictions induced on the input data are reduced by using the method according to the invention. The input data consist notably of a paving of the terrain as several nested regular grids. The content of each patch can notably be a set of arbitrary irregular triangular meshes.

Advantageously, the impact of the method according to the invention on the intrinsic performance of the image display is tiny.

1. A method of rendering a terrain stored in a massive database the said terrain rendering being displayed for an observer by a display device comprising at least one graphics card comprising a cache memory, comprising:
generating several regular grids of different resolution level terrain patches to represent the terrain data of the massive database;
extracting terrain data from the massive database for several resolution levels, the extracted terrain data forming an extraction pyramid composed of an extraction window for each level of detail, placed in cache memory;
selecting the patches of the extraction pyramid which contribute to the image; and
plotting the rendering on the basis of the selected patches.

2. The method according to claim 1, wherein the terrain data are extracted for several resolution levels so as to build an extraction pyramid, the extraction pyramid consisting of a sliding extraction window for each resolution level, the sliding extraction window being defined by an identical number of terrain patches which is fixed for all the resolution levels, the patches extending around a position termed the position of the centre of the sliding extraction window, the centre of the sliding extraction window evolving in real time as a function of the evolution of the position of a centre of interest, the centre of interest being determined as a function of the position of the observer with respect to the display device.

3. The method according to claim 1, wherein a sliding window is placed in cache memory, comprises an active zone intended to be displayed, and a preloading zone which makes it possible to anticipate the transfers of the said data.

4. The method according to claim 2, wherein the width of a sliding extraction window is defined by an even number of terrain patches.

5. The method of rendering according to claim 2, wherein an extraction pyramid comprising for each different resolution level a sliding extraction window consisting of a grid of patches, the spacing of displacement of the centre of a sliding extraction window of resolution level L, is aligned with the spacing of a grid of resolution level L+1, L being an integer, resolution level L+1 being less detailed than resolution level L.

6. The method of rendering according to claim 5, wherein the different resolution grids of the sliding window form a quaternary tree, each level of the tree corresponding to a resolution level.

7. The method of rendering according to claim 6, wherein the rendering of each patch of the sliding window is determined by traversing the quaternary tree depth-wise from the least resolved level to the most resolved level.

8. The method of rendering according to claim 7, wherein each patch P of level L in intersection with the field of vision, and situated in the margin of transition of the resolution level L−1, is plotted by mixing the patch P with its children in the quaternary tree.
